(19) United States
(12) Patent Application Publication
(10) Pub. No.: US 2022/0284355 A1
(43) Pub. Date: Sep. 8, 2022

(54) CROWD-SOURCED PERFORMANCE ACTION SELECTION RECOGNITION AT A VENUE IN WHICH THE SELECTED ACTION IS PERFORMED

(71) Applicants: Steven M Greenberg, Boynton Beach, FL (US); Eduardo Burillo, Key Biscayne, FL (US)

(72) Inventors: Steven M Greenberg, Boynton Beach, FL (US); Eduardo Burillo, Key Biscayne, FL (US)

(21) Appl. No.: 17/194,631

(22) Filed: Mar. 8, 2021

(51) Int. Cl. G06Q 10/02; G06Q 30/06

(52) U.S. Cl. CPC G06Q 10/02; G06Q 30/06

(57) ABSTRACT

Embodiments of the present invention provide a method, system and computer program product for crowd-sourced event management. A method for crowd-sourced event management includes receiving from a purchaser from over a computer communications network, a selection to purchase an admissions ticket to an event scheduled for performance on a particular date at a particular venue and assigning a seat within the venue to the purchaser. A specification also is received from over the computer communications network, by the purchaser, of a specific action to be performed during the performance. Later, it is determined whether or not to perform the specific action during the performance and in the event that the specific action is determined to be performed during the performance, a message is displayed at the venue indicating the determination along with a portion of the venue including the assigned seat.

### BACKGROUND OF THE INVENTION

### Field of the Invention

The present invention relates to the field of event performance management, and more particularly to the management of interactive fan participation in a performance.

### Description of the Related Art

The public performance for the purpose of entertainment has been part and parcel of society since the dawn of time. In modern times, it is common for a performance to be scheduled to occur on a specific date at a specific venue by a specific performer, and thereafter for admissions tickets to be sold for the benefit of the performer, the venue and the organizer of the performance, each admissions ticket entitling the purchaser a right to attend and witness the performance. In some instances, the admission ticket also entitles the purchaser additional privileges such as the right to receive discounted or free merchandise, or to more intimately interact with the performer before, after or during the performance—a common form of additional privileges being the venerable “backstage pass”.

The purpose of organizing and hosting a live performance, whether that performance is a live sporting event, or a live musical or theatrical performance, or a speech or comedic routine, is to immerse the live attendee into the performance in a way that is not possible when the performance is viewed remotely via television or streaming broadcast or after tape delay. Given the rising cost of admissions tickets, however, it is difficult to motivate the public to repeatedly purchase tickets as fans. For many professional sports, declining attendance at games is a substantial problem. Thus, it is now common to involve the spectating audience at a live performance in the performance itself, such as when a performer invites a spectator into the stage, or when a video camera captures live imagery of a specific fan in attendance, or when the commentary or reaction by a fan to an event in the performance is broadcast to all fans in attendance at the performance.

Recent trends in live performance organization involve the interactive participation by online viewers of the performance—namely an interactive sports league. In the interactive sports league, different fans associated with a specific team in the league “call in” plays in real time which plays are then performed by the team. In this way, the game performance is a live acted version of a video game in which the player selects the plays from amongst a pre-selection of plays able to be performed. Even still, while so much has proven feasible for a sports league committed to fan participation at each play, so much is not feasible for a pre-existing professional sports league in which it is the aim of the management of each team in the league to prevail which requires the professional judgement of the management—not the amateur judgment of a spectator. Thus, the aim of the performance conflicts with the desire to more fully engage the spectator in an interactive experience.

### BRIEF SUMMARY OF THE INVENTION

Embodiments of the present invention address deficiencies of the art in respect to interactive fan participation in a performance, and provide a novel and non-obvious method, system and computer program product for crowd-sourced event management in which recognition of a fan is provided to all attendees of a contemporaneous performance based upon the fan having selected an action chosen by the performer to be performed during the contemporaneous performance, so as to promote fan participation by all fans not only at the contemporaneous performance, but also at future performances without prejudicing the success of the contemporaneous performance. In this way, interactive fan participation can be moderated to permit the “business as usual” conduct of the performance while allowing for acceptable moments of fan participation and while boosting awareness of those acceptable moments so as to encourage even greater fan participation.

In an embodiment of the invention, a method for crowd-sourced event management includes receiving from a purchaser from over a computer communications network, a selection to purchase an admissions ticket to an event scheduled for performance on a particular date at a particular venue and assigning a seat within the venue to the purchaser. A specification also is received from over the computer communications network, by the purchaser, of a specific action to be performed during the performance. Later, it is determined whether or not to perform the specific action during the performance and in the event that the specific action is determined to be performed during the performance, a message is displayed at the venue indicating the determination along with a portion of the venue including the assigned seat.

In one aspect of the embodiment, the specific action is specified to be conditional upon a particular state of the performance so that the specific action is performed in response to one state of the performance, but the specific action is not performed in response to any other state of the performance. In another aspect of the embodiment, different specifications of different specific actions for different performances by different purchasers are recorded for all purchasers of admissions tickets for a multiplicity of performances and an outcome of each of the different specific actions additionally recorded in association with corresponding ones of the purchasers, so that when displaying the message, statistics for the purchaser are included in the message. In yet another aspect of the embodiment, video content from the purchaser is received during the specification of the specific action and a portion of the video content is included in the message displayed at the venue.

In a further aspect of the embodiment, the specification by the purchaser of the specific action to be performed during the performance includes an acceptance of payment of a surcharge above a base cost of the admissions ticket and an assessment of the payment only upon performance of the specific action. To that end, in even yet a further aspect of the embodiment, the specific action is specified from amongst a multiplicity of different possible specific actions. For each of the specific actions the surcharge must exceed a highest value established by other purchasers specifying the specific action. Then, only a subset of the multiplicity of different possible specific actions, having respective surcharges highest in value in respect to all other surcharges accepted for all others of the multiplicity of different possible specific actions, is performed at the performance while specific actions with lower valued surcharges are not performed.

In another embodiment of the invention, a data processing system is adapted for crowd-sourced event management. The system includes a host computing platform having one or more computers, each with memory and at least one processor. The system also includes a crowd-sourced action selection module. The module is defined by computer program instructions enabled while executing in the host computing platform to receive from a purchaser from over a computer communications network, a selection to purchase an admissions ticket to an event scheduled for performance on a particular date at a particular venue, to assign a seat within the venue to the purchaser, to receive from over the computer communications network, a specification by the purchaser of a specific action to be performed during the performance, to determine whether or not to perform the specific action during the performance, and on condition that the specific action is determined to be performed during the performance, to display a message at the venue indicating the determination along with a portion of the venue including the assigned seat.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for crowd-sourced event management;

FIG. 2 is a schematic diagram depicting a data processing system adapted for crowd-sourced event management; and,

FIG. 3 is a flow chart illustrating a process for crowd-sourced event management.

### DETAILED DESCRIPTION OF THE INVENTION

Embodiments of the invention provide for crowd-sourced event management. In accordance with an embodiment of the invention, as tickets to a planned performance are published for sale over a computer communications network, different purchasers of the tickets assigned to different seats within a venue at which the performance is planned, are afforded the opportunity to specify a specific action to be performed at the planned performance. The specific action can include, for example, a specific play to be performed at a sporting event, or a specific song or dance to be executed at a concert. Thereafter, in the event that the specific action is selected to be performed by the performer, or alternatively, in the event that the performance of the specific action is determined to have been successful, a message can be displayed in the venue, for viewing by all attendees at the venue, which recognizes the purchaser associated with the selected action and includes a location of the purchaser at the venue in respect to an assigned seat of the purchaser so that all attendees at the performance can recognize the purchaser in the venue.

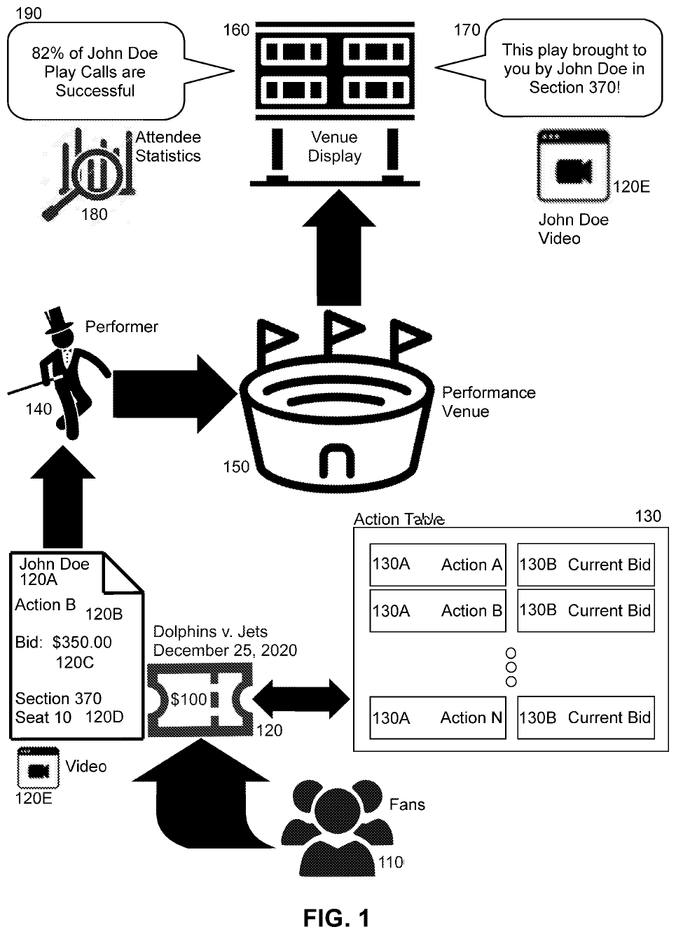

In further illustration, FIG. 1 pictorially shows a process for crowd-sourced event management. As shown in FIG. 1, different fans 110 purchase respective admissions tickets 120 to a pre-scheduled performance at a particular venue 150, the performance including, by way of example, an athletic contest, music concert, speech or theatrical performance. Upon purchasing an admissions ticket 120, a corresponding one of the fans 110 purchasing the admissions ticket 120 may be assigned to specific seating 120D within the venue 150. As such, each admission ticket 120 can specify a name 120A of the corresponding one of the fans 110 purchasing the admissions ticket 120 and the assigned seating 120D.

Notably, the corresponding one of the fans 110 purchasing the admissions ticket 120 at the time of purchasing the admissions ticket 120 can specify an action 120B to be performed during the performance. In one aspect of the embodiment, the action 120B can be a free-form action such as a custom play for a sporting event, or specific song for a music concert. But, in other aspects of the embodiment, the action 120B can be selected from amongst a set of available actions 130A set forth in an action table 130, for instance a set of available plays for a sporting event already known to the athlete performer 140, or a catalog of songs available for live performance by the musical performer 140.

Optionally, each of the available actions 130A in the action table 130 can include a highest bid 130B received for the corresponding one of the available actions 130A. As such, in selecting one of the available actions 130A as the specified action 120B, the corresponding one of the fans 110 purchasing the admissions ticket 120 also agrees to submit to a surcharge 120C which at least exceeds the highest bid 130A contemporaneously recorded for the selected one of the available actions 130A. Ultimately, only those one or more of the actions 130A in the action table 130 which are specified by different ones of the fans 110 having a highest value of the highest bid 130A or having a value of the highest bid 130A above a minimum threshold will be considered for performance by the performer 140.

At the time of the performance at the venue 150, the performer 140, whether the performer 140 is an athlete, musician, musical group, athletic team, coach of an athletic team or producer of a musical act, to name only a few examples, may elect to perform the specified action 120B of the corresponding one of the fans 110 purchasing the admissions ticket 120. In that case, at any time from the decision to perform the specified action 120B until after the specified action 120B has been performed, a message 170 may be displayed in a display 160 for the venue 150, such as a scoreboard. The message 170 identifies the name 120A of the corresponding one of the fans 110 purchasing the admissions ticket 120 in reference to the specified action 120B.

Optionally, a video clip 120E supplied by the corresponding one of the fans 110 purchasing the admissions ticket 120 at the time of purchasing the admissions ticket 120 may be played back as part of the message 170. For example, the video clip 120E can include an explanation of why the corresponding one of the fans 110 purchasing the admissions ticket 120 preferred the specified action 120B, or a more general greeting to the fans 110 in the venue 150, to name two possibilities. As well, the message 170 specifies the actual or general location of the corresponding one of the fans 110 purchasing the admissions ticket 120 in reference to the seat assignment 120D, as can be seen.

In one aspect of the embodiment, the message 170 is displayed only if it is determined that the specified action 120B was successful. In this regard, the specified action 120B will be considered successful if the result of the specified action 120B is to achieve a threshold score in the case of an athletic contest, a threshold achievement of progress in the case of an athletic contest, or a threshold prevention of an achievement by an opponent in the case of an athletic contest. Alternatively, the specified action 120B will be considered successful if the result of the specified action 120B is to achieve a degree of approval amongst the fans 110 in the venue 150, for instance by measuring a reaction to the performance of the specified action 120B in terms of sound level of the venue 150, or a duration of sound sensed in the venue beyond a threshold period of time within the venue 150. As yet another alternative, the specified action 120B will be considered successful upon receipt from the performer 140 of an indication of success.

In another aspect of the embodiment, various statistics 180 can be tracked for each of the fans 110 contributing specified actions 120B. Those statistics 180 can include a percentage of instances when the specified actions 120B of a corresponding one of the fans 110 are accepted by the performer 140, or a percentage of instances when the specified actions 120B of a corresponding one of the fans 110 are accepted by the performer 140 and determined to be successful. In the event that the statistics 180 are computed for the corresponding one of the fans 110 purchasing the admissions ticket 120, the message 170 also will include an indication 190 of the statistics 180 for the corresponding one of the fans 110 purchasing the admissions ticket 120.

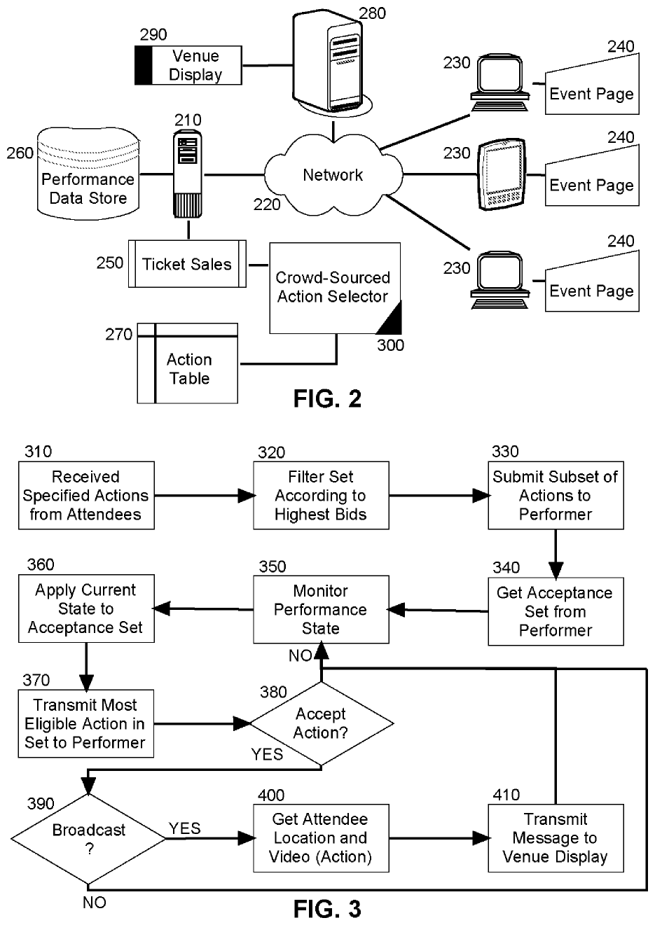

The process described in connection with FIG. 1 can be implemented within a computer data processing system. In further illustration, FIG. 2 schematically shows a data processing system adapted for crowd-sourced event management. The system includes a host computing platform 210 that includes one or more computers, each with memory and at least one processor. The host computing platform 210 is communicatively coupled to different client devices 230 over computer communications network 220. A ticket sales computer program 250 executes in the memory of the host computing platform 210 and provides a user interface 240 to each of the client devices 230 through which a corresponding fan both can select a ticket to a pre-scheduled performance for purchase, and also select seating at a venue for the pre-scheduled performance.

Importantly, the system includes crowd-sourced action selection module 300. The module 300 includes computer program instructions adapted upon execution by the one or more processors of the host computing platform 210, to also receive in the user interface 240 a selection of an action within action table 270. The action table 270 includes one or more actions which may be performed by a performer at the pre-scheduled performance. Examples include the playing of a specific song at a concert or theatrical presentation, the dancing of a specific dance at a ballet, the discussion of a particular topic at a speech, the re-telling of a specific story at an interview, the re-canting of a specific comedy routine at a stand-up comedy presentation, or the execution of a specific play at an athletic event, to name some examples.

The program instructions further may be adapted to receive a bid for payment of a surcharge by a corresponding selecting fan should the specified action from the action table 270 be chosen for performance by a performer at the pre-scheduled performance. The program instructions yet further may be adapted to respond to an indication from the performer at the pre-scheduled performance that a specified action is to be performed by messaging a venue server 280 over the computer communications network 220 to display in a venue display 290, a message identifying a location within the venue of the fan who had proposed the specified action. The program instructions even yet further may be adapted to include in the message, different performance statistics for the fan who had proposed the specified action, as recorded in a performance data store 260.

In even yet further illustration of the operation of the crowd-sourced action selection module 300, FIG. 3 is a flow chart illustrating a process for crowd-sourced event management. Beginning in block 310, different actions are specified for a pre-scheduled performance by correspondingly different ticket holders to the pre-scheduled performance. In block 320, the different actions may be filtered according to highest bid for each of the actions so that only a subset of the actions of the highest bid values remain. Then, in block 330, the subset of the specified actions can be messaged to a data communications device of a performer or agent of the performer and in block 340, a response is received from the device indicating one or more of the actions in the subset accepted for the possibility, but not guarantee of performance at the pre-scheduled performance.

In block 350, a state of the pre-scheduled performance may be monitored, ranging from a time that has elapsed since a start of the pre-scheduled performance (or a time remaining) to the occurrence of specific events or outcomes in the pre-scheduled performance such as a particular score or particular condition during the state of play of the performance, a last event which had occurred during the performance, and the like. Then, in block 360 the current state of the pre-scheduled performance is compared to the actions in the subset to the extent that some of the actions may be conditioned upon the contemporaneous state of the pre-scheduled performance. For example, a specified action may be conditioned to occur only if a certain condition exists during an athletic competition, or if a certain score differential exists during an athletic competition, or if a certain amount of time has elapsed since a start of an athletic competition, or if only a certain amount of time remains before a conclusion of an athletic competition, to name only a few examples.

In block 370, a most eligible action amongst the accepted actions of the subset subject to the applied contemporaneous state is transmitted to the performer for performance. In decision block 380, it is determined whether or not the performer has determined to perform the most eligible action, imminently. If so, in decision block 390 it can be determined whether or not to broadcast within a venue of the pre-scheduled performance, attribution to the fan corresponding to the most eligible action. For instance, it may be determined to broadcast attribution only upon determining as well that the performance of the most eligible action has been successful or is well-received by the other fans within the venue. If so, in block 400 a location within the venue of the fan corresponding to the most eligible action is determined and any corresponding video uploaded by the fan retrieved. Then, in block 410 a message is displayed in a display of the venue attributing the performance of the most eligible action to the fan at a location of the fan and playing back at least a portion of the video. In this way, fan participation can be encouraged owing to the venue wide attribution of the fan and recognition by other fans of the contribution of the specified action that had been performed by the performer.

The present invention may be embodied within a system, a method, a computer program product or any combination thereof. The computer program product may include a non-transitory computer readable storage medium or media having computer readable program instructions stored thereon, which when executed within the computer, cause one or more processors to perform different processes exemplary of different aspects of the present invention. To that end, the non-transitory computer readable storage medium can be a tangible device that can retain and store instructions for use by an instruction execution device such as a processor (central processing unit or “CPU”).

Aside from direct loading from memory for execution by one or more cores of a CPU or multiple CPUs, the computer readable program instructions described herein alternatively can be downloaded from over a computer communications network into the memory of a computer for execution therein. As well, only a portion of the program instructions may be retrieved into memory of the computing device from over a computer communications network, while other portions may be loaded from persistent storage of the computing device. Even further, only a portion of the program instructions may execute by one or more processing cores of one or more CPUs of the computing devices while other portions may cooperatively execute within a different computing device positioned remotely over the computer communications network with results of the computing by both devices shared therebetween.

Even yet further, as it is to be understood, one or more aspects of the present invention have been described herein with reference to flowchart illustrations and/or block diagrams of methods, apparatus (data processing systems), and computer program products according to embodiments of the invention. It will be understood that each block of the flowchart illustrations and/or block diagrams, and combinations of blocks in the flowchart illustrations and/or block diagrams, can be implemented by computer readable program instructions in various combinations. These computer readable program instructions may be provided to a CPU of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for crowd-sourced event management comprising:
receiving from a purchaser from over a computer communications network, a selection to purchase an admissions ticket to an event scheduled for performance on a particular date at a particular venue;
assigning a seat within the venue to the purchaser;
receiving from over the computer communications network, a specification by the purchaser of a specific action to be performed during the performance;
determining whether or not to perform the specific action during the performance; and,
on condition that the specific action is determined to be performed during the performance, displaying a message at the venue indicating the determination along with a portion of the venue including the assigned seat.

2. The method of claim 1, wherein the specific action is specified to be conditional upon a particular state of the performance so that the specific action is performed in response to one state of the performance but the specific action is not performed in response to any other state of the performance.

3. The method of claim 1, wherein different specifications of different specific actions for different performances by different purchasers are recorded for all purchasers of admissions tickets for a multiplicity of performances and an outcome of each of the different specific actions additionally recorded in association with corresponding ones of the purchasers, so that when displaying the message, statistics for the purchaser are included in the message.

4. The method of claim 1, wherein the specification by the purchaser of the specific action to be performed during the performance includes an acceptance of payment of a surcharge above a base cost of the admissions ticket and an assessment of the payment only upon performance of the specific action.

5. The method of claim 4, wherein the specific action is specified from amongst a multiplicity of different possible specific actions, and the surcharge exceeds a highest value established by other purchasers specifying the specific action such that only a subset of the multiplicity of different possible specific actions, having respective surcharges highest in value in respect to all other surcharges accepted for all others of the multiplicity of different possible specific actions, is performed at the performance.

6. The method of claim 1, wherein video content from the purchaser is received during the specification of the specific action and a portion of the video content is included in the message displayed at the venue.

7. A data processing system adapted for crowd-sourced event management, the system comprising:
a host computing platform comprising one or more computers, each comprising memory and at least one processor; and,
a crowd-sourced action selection module comprising computer program instructions enabled while executing in the host computing platform to perform:
receiving from a purchaser from over a computer communications network, a selection to purchase an admissions ticket to an event scheduled for performance on a particular date at a particular venue;
assigning a seat within the venue to the purchaser;
receiving from over the computer communications network, a specification by the purchaser of a specific action to be performed during the performance;
determining whether or not to perform the specific action during the performance; and,
on condition that the specific action is determined to be performed during the performance, displaying a message at the venue indicating the determination along with a portion of the venue including the assigned seat.

8. The system of claim 7, wherein the specific action is specified to be conditional upon a particular state of the performance so that the specific action is performed in response to one state of the performance but the specific action is not performed in response to any other state of the performance.

9. The system of claim 7, wherein different specifications of different specific actions for different performances by different purchasers are recorded for all purchasers of admissions tickets for a multiplicity of performances and an outcome of each of the different specific actions additionally recorded in association with corresponding ones of the purchasers, so that when displaying the message, statistics for the purchaser are included in the message.

10. The system of claim 7, wherein the specification by the purchaser of the specific action to be performed during the performance includes an acceptance of payment of a surcharge above a base cost of the admissions ticket and an assessment of the payment only upon performance of the specific action.

11. The system of claim 10, wherein the specific action is specified from amongst a multiplicity of different possible specific actions, and the surcharge exceeds a highest value established by other purchasers specifying the specific action such that only a subset of the multiplicity of different possible specific actions, having respective surcharges highest in value in respect to all other surcharges accepted for all others of the multiplicity of different possible specific actions, is performed at the performance.

12. The system of claim 7, wherein video content from the purchaser is received during the specification of the specific action and a portion of the video content is included in the message displayed at the venue.

13. A computer program product for crowd-sourced event management, the computer program product including a computer readable storage medium having program instructions embodied therewith, the program instructions executable by a device to cause the device to perform a method including:
receiving from a purchaser from over a computer communications network, a selection to purchase an admissions ticket to an event scheduled for performance on a particular date at a particular venue;
assigning a seat within the venue to the purchaser;
receiving from over the computer communications network, a specification by the purchaser of a specific action to be performed during the performance;
determining whether or not to perform the specific action during the performance; and,
on condition that the specific action is determined to be performed during the performance, displaying a message at the venue indicating the determination along with a portion of the venue including the assigned seat.

14. The computer program product of claim 13, wherein the specific action is specified to be conditional upon a particular state of the performance so that the specific action is performed in response to one state of the performance but the specific action is not performed in response to any other state of the performance.

15. The computer program product of claim 13, wherein different specifications of different specific actions for different performances by different purchasers are recorded for all purchasers of admissions tickets for a multiplicity of performances and an outcome of each of the different specific actions additionally recorded in association with corresponding ones of the purchasers, so that when displaying the message, statistics for the purchaser are included in the message.

16. The computer program product of claim 13, wherein the specification by the purchaser of the specific action to be performed during the performance includes an acceptance of payment of a surcharge above a base cost of the admissions ticket and an assessment of the payment only upon performance of the specific action.

17. The computer program product of claim 16, wherein the specific action is specified from amongst a multiplicity of different possible specific actions, and the surcharge exceeds a highest value established by other purchasers specifying the specific action such that only a subset of the multiplicity of different possible specific actions, having respective surcharges highest in value in respect to all other surcharges accepted for all others of the multiplicity of different possible specific actions, is performed at the performance.

18. The computer program product of claim 13, wherein video content from the purchaser is received during the specification of the specific action and a portion of the video content is included in the message displayed at the venue.
